(19) United States
(12) Patent Application Publication
(10) Pub. No.: US 2010/0314983 A1
(43) Pub. Date: Dec. 16, 2010

(54) LIGHT EMITTING DIODE LAMP WITH ENHANCED HEAT-CONDUCTING PERFORMANCE

(76) Inventor: Shih-Ming CHEN, Yingge Township (TW)

Correspondence Address: HDLS Patent & Trademark Services, P.O. BOX 220746, CHANTILLY, VA, 20153-0746, US

(21) Appl. No.: 12/482,617

(22) Filed: Jun. 11, 2009

(51) Int. Cl. H01J 7/24

(52) U.S. Cl. 313/45

(57) ABSTRACT

A light-emitting diode lamp with enhanced heat-conducting performance includes a light-emitting module, a heat sink and an elastic piece. The light-emitting module includes an insulating base, a light-emitting diode and a heat-conducting plate. The light-emitting diode is fixed to the insulating base. The heat-conducting plate partially surrounds the exterior of the insulating base to thermally contact the light-emitting diode. The heat sink is provided with a through-hole. The light-emitting module is inserted into the through-hole. The elastic piece is arranged between the heat-conducting plate and the insulating base to push the heat-conducting plate to thermally contact the heat sink. With the elastic piece propping the heat-conducting plate open, the outer surfaces of the heat-conducting plate can be tightly adhered to the inner walls of the through-hole, thereby enhancing the heat-conducting efficiency.

### BACKGROUND OF THE INVENTION

1. Field of the Invention

The present invention relates to a light-emitting diode lamp, and in particular to a light-emitting diode lamp with enhanced heat-conducting performance.

2. Description of Prior Art

Currently, light-emitting diodes have been widely used in the field of lighting. With the increasing power of the light-emitting diode, how to dissipate the high amount of waste heat generated thereby has become an important issue for the manufacturers in this field of art.

The conventional light-emitting diode device usually includes a light-emitting diode, a heat-conducting block and a heat sink. The bottom surface of the light-emitting diode is adhered to the heat-conducting block, and then the heat-conducting block is adhered to the heat sink. Usually, in order to enhance the heat-conducting efficiency of this device, the heat-conducting block will be tightly adhered to the heat sink. In order to make the heat-conducting block to be tightly adhered to the heat sink, both of them can be manufactured in a tight clearance fit while, for example, the heat-conducting block can be inserted into the heat sink. Another solution is to apply heat-conducting paste between the heat-conducting block and the heat sink, whereby the heat-conducting efficiency can be enhanced.

However, in practice, the above-mentioned light-emitting diode device still has some drawbacks. If the heat-conducting block and the heat sink are manufactured in a tight clearance fit, inserting the heat-conducting block into the heat sink will become more difficult. Further, owing to the tight clearance fit, the machining process for manufacturing these components will be inevitably difficult. On the other hand, it is more difficult to remove the heat-conducting block from the interior of the heat sink, which in turn impedes the detachment and repair of the light-emitting diode. Further, the other way of enhancing the heat-conducting efficiency via the heat-conducting paste also has to exert a pressure on the heat-conducting block to make the heat-conducting block tightly abut the heat sink otherwise the effect of the heat-conducting paste cannot be achieved.

Therefore, the present Inventor aims to overcome the above problems.

### SUMMARY OF THE INVENTION

The present invention is to provide a light-emitting diode lamp with enhanced heat-conducting performance. With an elastic piece propping the heat-conducting plate open, the outer surfaces of the heat-conducting plate can be tightly adhered to the inner walls of the through-hole of the heat sink. In this way, the heat-conducting efficiency and the heat-dissipating performance of the whole light-emitting diode device can be enhanced.

The present invention is to provide a light-emitting diode lamp with enhanced heat-conducting performance, which includes a light-emitting module, a heat sink and an elastic piece. The light-emitting module comprises an insulating base, a light-emitting diode and a heat-conducting plate. The light-emitting diode is fixed to the insulating base. The heat-conducting plate partially surrounds the exterior of the insulating base to thermally contact the light-emitting diode. The heat sink is provided with a through-hole. The light-emitting module is inserted into the through-hole. The elastic piece is disposed between the heat-conducting plate and the insulating base to push the heat-conducting plate to thermally contact the heat sink.

In comparison with prior art, according to the present invention, the elastic piece exerts a force on the heat-conducting plate to prop the heat-conducting plate open. In this way, the outer surfaces of the heat-conducting plate can be tightly adhered to the inner walls of the through-hole of the heat sink, thereby achieving a better heat-conducting performance and enhancing the heat-dissipating performance of the whole device.

### BRIEF DESCRIPTION OF THE DRAWINGS

FIG. 1 is an exploded perspective view of the present invention;

FIG. 2 is a perspective view showing the external appearance of the present invention;

FIG. 3 is a cross-sectional view taken along the line 3-3 of FIG. 2; and

FIG. 4 is an exploded perspective view showing another embodiment of the present invention.

### DETAILED DESCRIPTION OF THE INVENTION

The characteristics and technical contents of the present invention will be explained in more detail with reference to the accompanying drawings. However, the drawings are illustrative only but not used to limit the present invention.

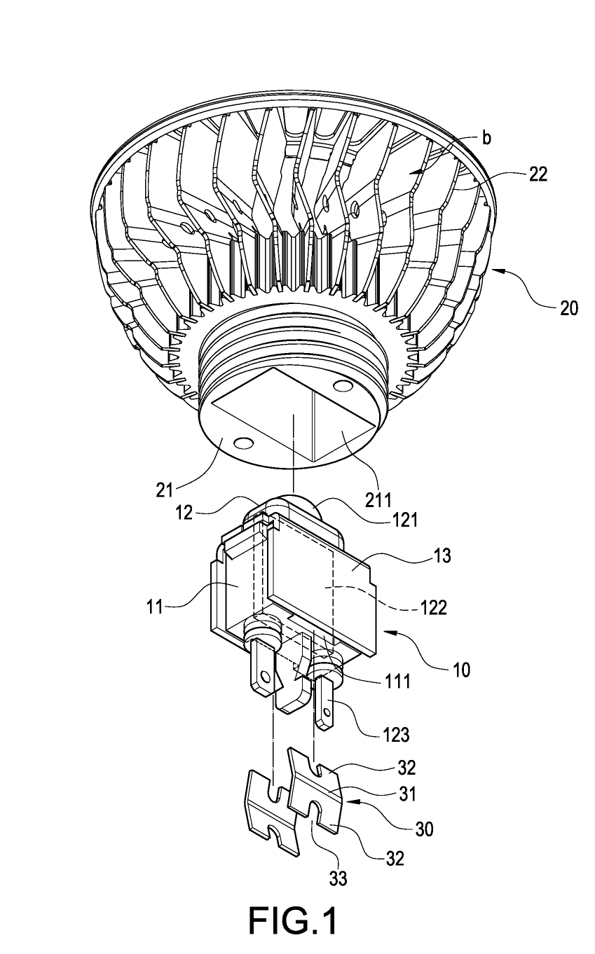

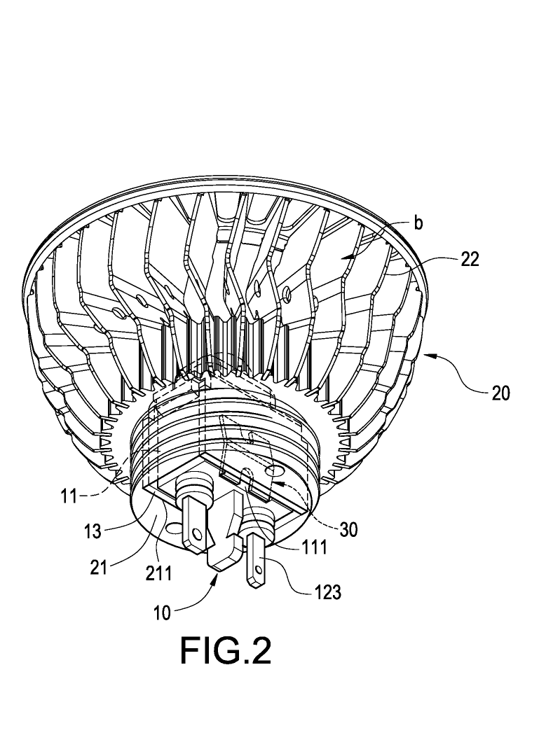

Please refer to FIGS. 1 and 2. FIG. 1 is an exploded perspective view of the present invention, and FIG. 2 is a perspective view showing the external appearance of the present invention. The present invention provides a light-emitting diode lamp 1 with enhanced heat-conducting performance, which includes a light-emitting module 10, a heat sink 20 and an elastic piece 30.

The light-emitting diode 10 comprises an insulating base 11, a light-emitting diode 12 and a heat-conducting plate 13.

In the present embodiment, the insulating base 11 is substantially formed into a rectangular shape. The light-emitting diode 12 is fixed in the insulating base 11. In practice, the insulating base 11 is made by means of a plastic injection forming process so as to cover the outside of the light-emitting diode 12.

The light-emitting diode 12 comprises a crystal 121, a circuit board 122 and a plurality of conductive terminals 123. The circuit board 122 is connected to the underside of the crystal 121. The conductive terminals 123 are connected to one end of the circuit board 122.

The heat-conductive plate 13 partially surrounds the exterior of the insulating base 11 to thermally contact the light-emitting diode 12. The heat-conducting plate 13 is brought into contact with the bottom surface of the crystal 121 to conduct the waste heat generated by the operation of the crystal 121. In the present embodiment, the heat-conducting plate 13 is substantially formed into an inverted “U” shape, but it is not limited thereto.

The heat sink 20 comprises a heat-dissipating post 21 and a plurality of heat-dissipating pieces 22. The heat-dissipating pieces 22 are connected to the top of the heat-dissipating post 21 and are arranged in a ring. A heat-dissipating passage b is formed between the respective heat-dissipating pieces 21.

The heat-dissipating post 21 is provided with a through-hole 211. The through-hole 211 is formed into a rectangular shape, but it is not limited thereto. The shape of the through-hole 211 corresponds to the profile of the light-emitting module 10. The light-emitting module 10 is inserted into the through-hole 211.

The elastic piece 30 is disposed between the heat-conducting plate 13 and the insulating base 11 to push the heat-conducting plate 13 to thermally contact the heat sink 20. With the elastic piece 30 propping the heat-conducting plate 13 open, the outer surfaces of the heat-conducting plate 13 can be tightly adhered to the inner walls of the through-hole 211. The elastic piece 30 is made of a metallic material and is formed into a “V’ shape. In the present embodiment, there are two elastic pieces 30 arranged on both sides of the insulating base 11. However, the arrangement of the elastic pieces 30 is not limited to this illustrated form.

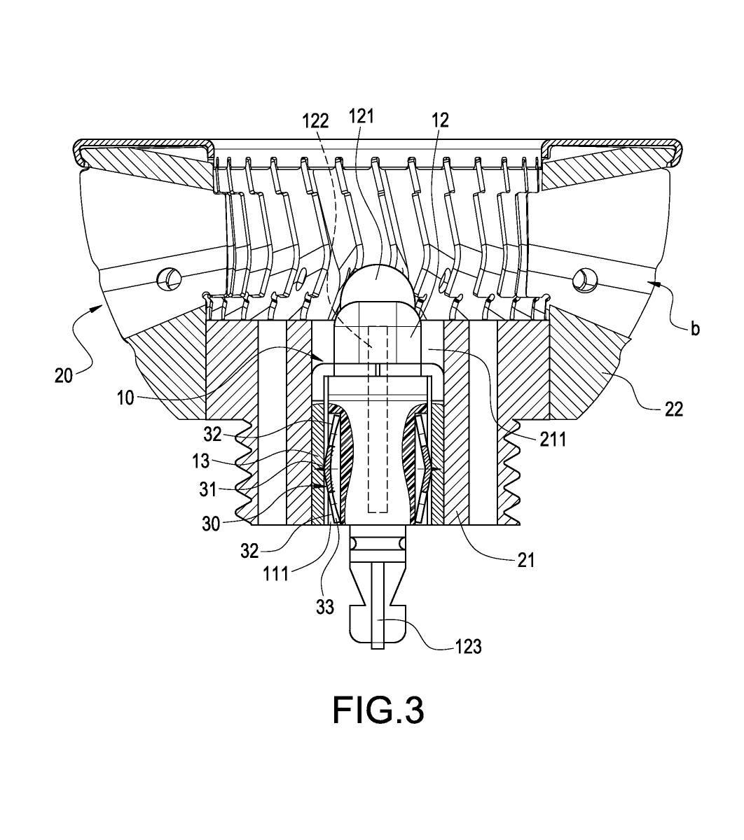

Please refer to FIG. 3, which is a cross-sectional view taken along the line 3-3 of FIG. 2. In the present embodiment, the elastic piece 30 has a bending section 31 and two distal ends 32 extending from both ends of the bending section 31. When the elastic piece 30 is disposed between the insulating base 11 and the heat-conducting plate 13, the bending section 31 abuts the heat-conducting plate 13 and the distal ends 32 abut the insulating base 11. However, it should be noted that the structure of the elastic piece 30 is not limited thereto. When the heat-conducting plate 13 is abutted by the bending section 31, the heat-conducting plate 13 will be propped open, so that its outer surfaces can be tightly adhered to the inner walls of the through-hole 211. Further, the distal ends 32 of the elastic piece 30 are provided with an open trough 33 respectively to increase the elasticity of the elastic piece 30.

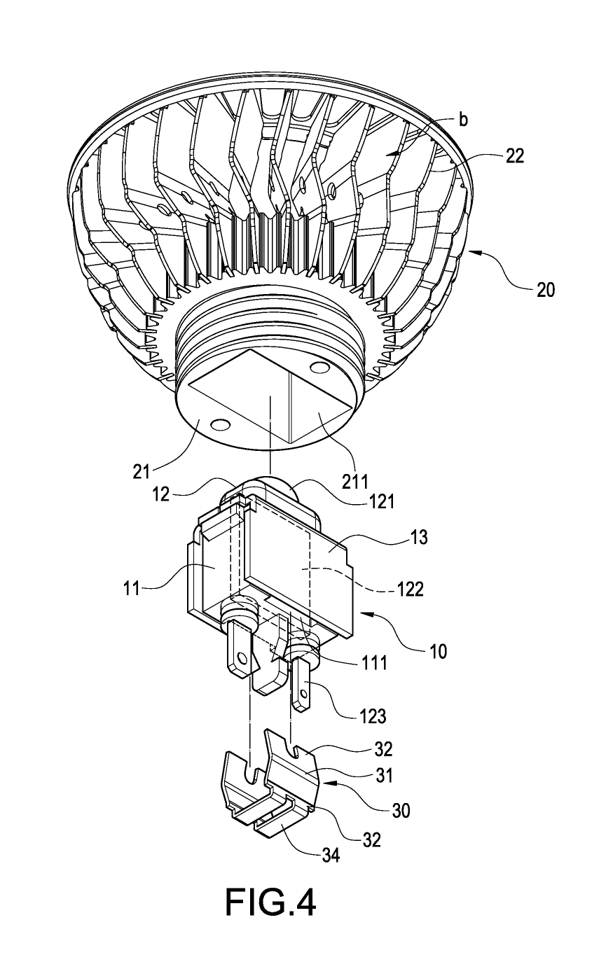

Please refer to FIG. 4, which is an exploded perspective view showing another embodiment of the present invention. In the present embodiment, there is only one elastic piece 30. The elastic piece 30 is formed into a “U” shape and comprises two spaced bending sections 31, a connecting section 34 and a distal end 32 formed on one side of the bending section 31. The connecting section 34 is connected to both of the bending sections 31.

When the elastic piece 30 is inserted between the insulating base 11 and the heat-conducting plate 13, the two bending sections 31 are disposed on both sides of the insulating base 11 respectively. Via this arrangement, only one elastic piece 30 is used to achieve the same effect of propping the heat-conducting plate 13 open as that in the previous embodiment. Thus, the force exerted on the heat-conducting plate 13 can be distributed uniformly. Furthermore, since only one elastic piece 30 is used, the assembly thereof is much easier.

To sum up the above, the light-emitting diode lamp with enhanced heat-conducting performance according to the present invention really demonstrates industrial applicability, novelty and inventive steps. Further, the structure of the present invention has not been seen in products of the same kinds or let in public use, and thus the present invention conforms to the requirements for a utility model patent.

What is claimed is:

1. A light-emitting diode lamp with enhanced heat-conducting performance, comprising:
a light-emitting module having an insulating base, a light-emitting diode fixed to the insulating base, and a heat-conducting plate partially surrounding the exterior of the insulating base to thermally contact the light-emitting diode;
a heat sink provided with a through-hole, the light-emitting module being inserted into the through-hole; and
an elastic piece disposed between the heat-conducting plate and the insulating base to push the heat-conducting plate to thermally contact the heat sink.

2. The light-emitting diode lamp with enhanced heat-conducting performance according to claim 1, wherein the heat-conducting plate is substantially formed into a “U” shape, the elastic piece has a bending section and a distal end extending from each side of the bending section, the bending section abuts the heat-conducting plate, and the distal ends abut the insulating base.

3. The light-emitting diode lamp with enhanced heat-conducting performance according to claim 2, wherein the elastic piece is formed into a “V” shape.

4. The light-emitting diode lamp with enhanced heat-conducting performance according to claim 1, wherein the heat-conducting plate is substantially formed into a “U” shape, the elastic piece has two spaced bending sections, a plurality of distal ends extending from the bending sections and a connecting section for connecting the two bending sections, the bending sections abut the heat-conducting plate, and the distal ends abut the insulating base.

5. The light-emitting diode lamp with enhanced heat-conducting performance according to claim 4, wherein the elastic piece is substantially formed into a “U” shape.

6. The light-emitting diode lamp with enhanced heat-conducting performance according to claim 5, wherein the insulating base is provided with an accommodating trough for accommodating the elastic piece.

7. The light-emitting diode lamp with enhanced heat-conducting performance according to claim 6, wherein the distal ends of the elastic piece are provided with an open trough respectively.

8. The light-emitting diode lamp with enhanced heat-conducting performance according to claim 7, wherein the light-emitting diode comprises a crystal, a circuit board and a plurality of conductive terminals, the circuit board is connected to the bottom of the crystal, the conductive terminals are connected to one end of the circuit board.

9. The light-emitting diode lamp with enhanced heat-conducting performance according to claim 8, wherein the heat sink comprises a heat-dissipating post and a plurality of heat-dissipating pieces, the heat-dissipating pieces are connected to the top of the heat-dissipating post and are arranged in a ring, a heat-dissipating passage is formed between the respective heat-dissipating pieces.
